(19) United States
(12) Patent Application Publication
(10) Pub. No.: US 2005/0090240 A1
(43) Pub. Date: Apr. 28, 2005

(54) System and method for sending data to a mobile device in a wireless network

(75) Inventors: Leigh Michael Chinitz, Wellesley, MA (US); Sherman Shih, Cupertino, CA (US); Hilton Hong, San Jose, CA (US)

Correspondence Address: Robert E. Krebs;Thelen Reid & Priest, LLP, P.O. Box 640640, San Jose, CA, 95164-0640, US

(73) Assignee: Proxim Corporation, a Delaware Corporation

(21) Appl. No.: 10/765,726

(22) Filed: Jan. 26, 2004

Related U.S. Application Data
(60) Provisional application No. 60/443,139, filed on Jan. 27, 2003.

(51) Int. Cl. H04M 3/00

(52) U.S. Cl. 455/418; 455/445

(57) ABSTRACT

A system for wirelessly transmitting time constant data under a wireless protocol is contemplated. A access point device initiates a reservation of time under a protocol. The transmitting device then downloads the time constant data to the remote devices. This can take place as individual transmissions or a single unicast transmission of one block containing all the data for the remote wireless device(s). The access point polls each remote wireless device for constant time data to be sent to the remainder of the network. At the conclusion, the access point gives up the reservation so as to enable the remote wireless devices to use the access point for other forms of data traffic.

This application claims priority based on provisional application Ser. No. 60/443,139, entitled “System and Method for Sending Voice Data to and from a Mobile Device in a Wireless Network” by Hilton Hung filed on Jan. 27, 2003.

### FIELD OF THE INVENTION

The present invention relates to a wireless communication system. More particularly, the present invention is related to sending constant time data to a non-static device coupled to a wireless network.

### BACKGROUND

In some wireless networks, an access point (AP) can be coupled to a variety of wireless network devices. Typically, a wireless network can allow a mobile device to send and receive data as it moves through coverage zones of the individual access points. In some cases, the access point sends and/or receives constant-time dependent data, such as voice data to or from a wireless network device in its coverage zone. Typically, the wireless network devices contend for a time to send this data, and as such, data may be lost due to long contention waits or collisions.

A similar problem exists when the access point must send data to several wireless network devices. Each transmission of data to a specific wireless network device requires an overhead by the access point, thus slowing the overall time to reach all the wireless network devices with such constant time data.

At the moment, the 802.11e wireless standard provides mechanisms that help this problem. The first mechanism, designated as enhanced distributed coordination function (EDCF), is based on differentiating priorities at which traffic is to be delivered. This differentiation is achieved by varying the amount of time a station would sense the channel to be idle, the length of the contention window during a backoff, or the duration a station may transmit once it has the channel access.

Another mechanism allows for contention-free, as well as contention based, access to the wireless medium. This is known as the hybrid coordination function (HCF). A solution employing HCF allows for the reservation of transmission opportunities with a hybrid coordinator (HC). Based on the particular requirements, a wireless network device requests the HC for transmission opportunities—both for its own transmissions as well as transmissions from the HC to itself. The request itself may be initiated within the media access control (MAC) functionality of the wireless network device. Or, this may be requested by a station management functionality of the wireless network device.

The HC, based on an admission control policy, either accepts or rejects the request. If the request is accepted, it schedules transmission opportunities for the wireless network device. For transmissions for the wireless network device, the HC polls based on parameters supplied by the wireless network device.

Neither of these options is entirely satisfactory. The EDCF solution provides only statistically prioritized access to the medium, but does not guarantee latency for any packet stream. The HCF solution offers more predictable overhead, but requires the overhead of polling each wireless network device, as well as an additional layer of complexity in implementing the packet scheduler that is implied, but not defined, by the specification.

### SUMMARY

A system for wirelessly transmitting time constant data under a wireless protocol is contemplated. A access point device initiates a reservation of time under a protocol. The transmitting device then downloads the time constant data to the remote devices. This can take place as individual transmissions or a single unicast transmission of one block containing all the data for the remote wireless device(s). The access point polls each remote wireless device for constant time data to be sent to the remainder of the network. At the conclusion, the access point gives up the reservation so as to enable the remote wireless devices to use the access point for other forms of data traffic.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a network diagram of wireless network that enables constant bit rate data delivery, according to the invention.

FIG. 2 is a timing diagram detailing an interaction that may be used in the network detailed in FIG. 1.

FIG. 3 is a timing diagram detailing an interaction between the access point and the wireless network device for downlinking data to the wireless network devices.

FIG. 4 is a timing diagram detailing an exemplary combination of download and upload between the access point and the wireless network devices. At a time t6, a last packet is received.

### DETAILED DESCRIPTION

Embodiments of the present invention are described herein in the context of a System And Method For Sending Voice Data To and From A Mobile Device In A Wireless Network. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of digital systems, including hardware, software, or any combination thereof. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

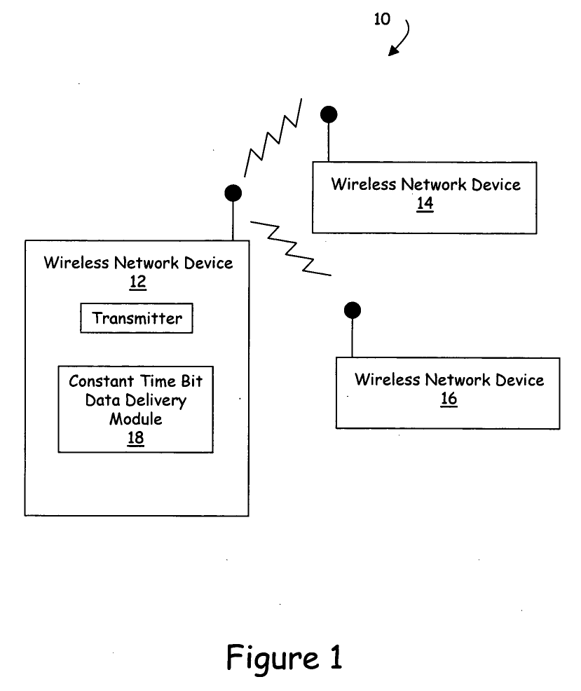

FIG. 1 is a network diagram of wireless network that enables constant bit rate data delivery, according to the invention. A wireless network 10 contains an access point 12, and one or more wireless network devices, such as wireless network device 14, and wireless network device 16. The access point 12 contains a portion 18 that enables the access point 12 to deliver constant bit rate data to the wireless network devices 14 and 16.

This diagram is explained in context of the 802.11 wireless protocol. However, it should be understood that this is not limiting, and that any wireless protocol may be used herein. Under the 802.11 protocol, the access point can deliver data to any wireless network device in its zone. Immediately following such a broadcast, a period of down time is enforced in the network, to allow for the receiving device to send an acknowledgement of the message.

After the acknowledgement, another time window is imposed on the devices to avoid collisions. This is known as the distributed coordination function (DCF) interframe space (DIFS). In this time period, no transmissions by devices in contact with the access point are allowed.

In the context of the present invention, the access point takes advantage of the DIFS to implement a constant bit data transmission scheme. Prior to the expiration of the DIFS, the access point broadcasts a signal that each of the wireless network devices expecting timed data is attuned for. This signal signifies one or more actions in this disclosure.

In one embodiment, the signal signifies to the wireless network devices expecting timed data that a block of such timed data is forthcoming from the access point to the various wireless network devices. In the signal, or after such signal, the access point transmits the timed data flowing to the wireless network devices in a single transmission block.

In our example, assume the wireless network devices 14 and 16 are operating in a voice transmission mode, or another mode that uses such timed data. When the access point signals the beginning of a timed data frame, the wireless network devices 14 and 16 know that the next transmission is such timed data.

In one example, the timed data is sent in a single block transmission. In this manner the wireless network devices 14 and 16 both receive the data and process the data block accordingly. In one possible scheme, the wireless network device 14, upon registration, is told by the access point that it shall have the first portion of data in a block. In the same manner, when the wireless network device 16 registers with the access point, the access point indicates that the data directed to the wireless network device 16 is contained in the second portion of the block. In this manner, a single block of timed data may be multicast to the various wireless network devices, and the remote wireless network devices may process the block accordingly. This optimizes the flow of data to the wireless network devices, since multiple transmissions need not be performed.

In another aspect, the upcoming data may be polled from the various wireless network devices. One way to accomplish this is to poll each wireless network device for its uplink data to be directed to the network 10. Accordingly, during this period, the access point first polls the wireless network device 14 for the upgoing data. At the conclusion of this transmission, the access point polls the wireless network device 16 for its upgoing data. In this manner, all upgoing timed data may be extracted.

The size of the upgoing transmissions can be easily managed, since this is typically time bit constant data. Thus, the access point can easily scale a frame to fit the expected traffic.

In performing these functions, the access point may reserve a block of time through network protocol. This can define a frame for the timed data bit transfer to take place. In one embodiment, the doweled block transmission, as described above, and the polled upload are coordinated together. Or, these functions can be performed separately. In this manner, a timing reference may be supplied by the access point to the associated wireless network device to define slots for the downlink and uplink of such constant data bit transfers.

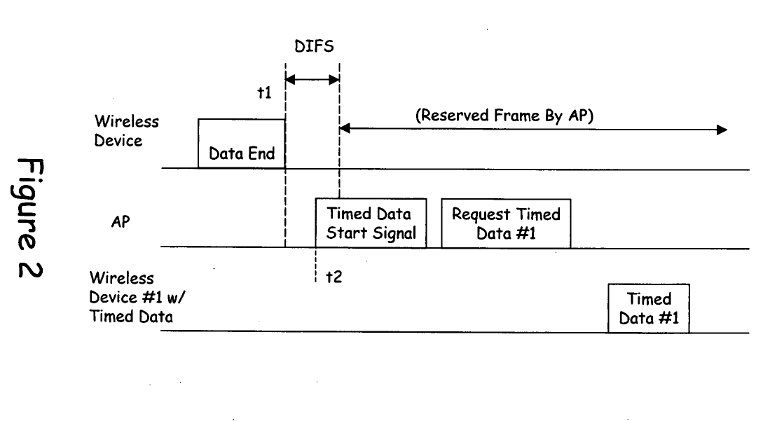

FIG. 2 is a timing diagram detailing an interaction that may be used in the network detailed in FIG. 1. At a time t1, a last packet is received from some data source. At a time t2, prior to the expiration of the DIFS, the access point produces a polling signal to the first wireless network device, initiating the upload of the data traveling to the network. This sequence continues for each wireless network device that is transmitting voice data to the network.

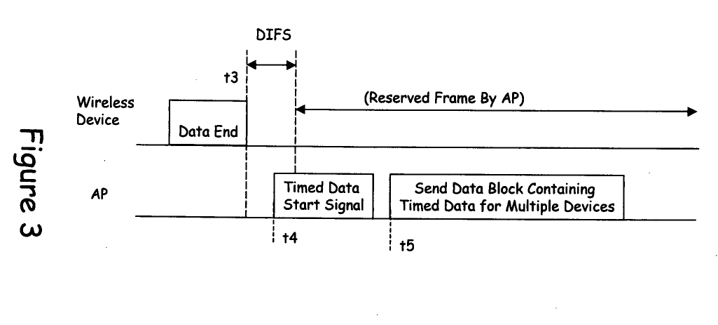

FIG. 3 is a timing diagram detailing an interaction between the access point and the wireless network device for downlinking data to the wireless network devices. At a time t3, a last packet is received. At a time t4, prior to the expiration of the DIFS, the access point produces signal to the wireless network devices, telling them to expect a block download of data. This signal inhibits any wireless network devices within the zone to send data, and may be used to reset any standoff characteristics of coupled wireless network devices. The data stream starts at a time t5. As said before, the appropriate wireless network device will pull the data from the block that is intended for it.

In another embodiment, a variation of the polling method of FIG. 2 may be used to download data. In this manner, the individual wireless network devices are sequentially polled to expect a download of data.

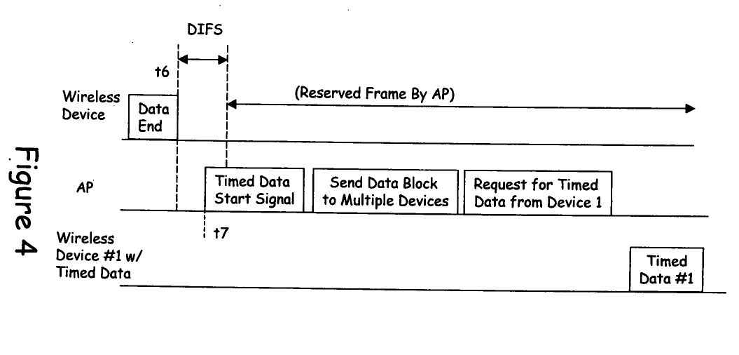

FIG. 4 is a timing diagram detailing an exemplary combination of download and upload between the access point and the wireless network devices. At a time t6, a last packet is received. At a time t7, prior to the expiration of the DIFS, the access point produces signal to the wireless network devices, telling them to expect a block download of data. Also, this signal delineates a frame in which the access point reserves, thus inhibiting collision from the rest of the network. Within this frame, the signals for the download data and upload data are depicted.

In one example, if the requested frame is shorter than expected, the access point can fill the frame with non-constant time bit data. When the filler data is through, the process can repeat. This can be accomplished in an efficient manner, since the access point simply adjusts for any jitter through the sending of the first signal delineating the start of a constant time bit data frame.

Thus, a System And Method For Sending Voice Data To and From A Mobile Device In A Wireless Network. is described and illustrated. Those skilled in the art will recognize that many modifications and variations of the present invention are possible without departing from the invention. Of course, the various features depicted in each of the Figures and the accompanying text may be combined together. Accordingly, it should be clearly understood that the present invention is not intended to be limited by the particular features specifically described and illustrated in the drawings, but the concept of the present invention is to be measured by the scope of the appended claims. It should be understood that various changes, substitutions, and alterations could be made hereto without departing from the spirit and scope of the invention as described by the appended claims that follow.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

1. A device for sending data to one or more wireless devices in a wireless network, the data being time constant digital data, the device comprising:
a first circuit for alerting the wireless devices that the time constant digital data is to be sent;
a second circuit for defining a frame in which the time constant digital data is to be sent; and
a third circuit for sending the digital data to the one or more wireless devices.

2. A device for sending data to a plurality of wireless devices in a wireless network, the data being time constant digital data, the device comprising:
a first circuit for alerting the wireless devices that the time constant digital data is to be sent;
a second circuit for defining a frame in which the time constant digital data is to be sent; and
a third circuit for sending the digital data as a single data block to the plurality of wireless devices within the frame.

3. A device for receiving data at one of a plurality of wireless devices in a wireless network, the data being time constant digital data, the device comprising:
a first circuit for receiving an alert that the time constant digital data is to be sent;
a second circuit for receiving parameters regarding a frame in which the time constant digital data is to be sent;
a third circuit for receiving the digital data as a single data block to the plurality of wireless devices within the frame; and
a fourth circuit for extracting the digital data bound for the one of a plurality of wireless devices from the single block of data.

4. A device for receiving data from one or more wireless devices in a wireless network, the data being time constant digital data, the device comprising:
a first circuit for alerting the wireless devices that the time constant digital data is to be sent;
a second circuit for defining a frame in which the time constant digital data is to be sent;
a third circuit for polling the particular wireless device to initiate the sending of the digital data; and
a fourth circuit for receiving the data sent from each particular polled wireless device.

5. A method for receiving digital data from a wireless device in a wireless network, the method comprising:
alerting the wireless device to send the time constant data;
polling the wireless device to send the time constant data; and
receiving a sent packet of time constant data from the particular wireless device.

6. A method for sending digital data from a wireless device in a wireless network, the method comprising:
awaiting an Alert to send the time constant data;
subsequent to the alert, awaiting a Poll to send the time constant data; and
sending a sent packet of time constant data from the particular wireless device.

7. A method for sending digital data to a plurality of wireless devices in a wireless network, the method comprising:
alerting the plurality of wireless devices to receive the time constant data; and
sending one block of data, the one block of data comprising all of the data destined for the plurality of wireless devices.
